(19) United States
(12) Patent Application Publication
(10) Pub. No.: US 2026/0366591 A1
(43) Pub. Date: Nov. 19, 2026

(54) ADJUSTABLE ROTATION DAMPER

(71) Applicant: Schwarz GmbH, Althengstett (DE)

(72) Inventors: Dimitri SVYRSKY, Pforzheim (DE); Bernhard HOMNER, Calw (DE)

(21) Appl. No.: 19/130,924

(22) PCT Filed: Nov. 23, 2023
(86) PCT No.: PCT/EP2023/082861

§ 371 Date: May 16, 2025

(30) Foreign Application Priority Data
Nov. 24, 2022 (DE) 20 2022 106 594.2

(51) Int. Cl. F16F 9/14; F16F 9/516

(52) U.S. Cl. CPC F16F 9/145; F16F 9/516

(57) ABSTRACT

A rotation damper comprises substantially tubular housing with a stop extending radially inwards from inner cylindrical surface thereof, rotor chamber delimited by inner cylindrical surface, and adjustment chamber. Rotor chamber and adjustment chamber are separated by intermediate wall as part of housing extending radially inwards with through-opening as part of channel for viscous fluid, and rotor with rotor blade formed as cylindrical segment is introduced into rotor chamber with viscous fluid and rotatably mounted therein about rotational axis and rotatable from first to second stop surface of the stop. Rotor divides rotor chamber into first and second sub-chambers fluidically connected by channel. Control element in adjustment chamber for adjusting cross-section of channel comprises force transmission element and slide with protrusion extending circumferentially and complementing intermediate wall through-opening as slot extending at least partly circumferentially and engaging therein for axial movement along rotational axis for adjusting cross-section of channel.

The invention relates to an adjustable rotation damper of the type specified in the preamble of claim 1.

Rotation dampers are known from EP 0 997 869 B1 and DE 10 2017 215 830 A1, among others. The damping provided by both these rotation dampers is dependent on the direction of rotation and on the angle of rotation. The damping is defined based on the configuration of individual components before the assembly process.

EP 3 736 466 A1 features an adjustable rotation damper. Its adjustability is ensured by an adjusting nut which is introduced into an adjustment chamber. Axial adjustment or moving the adjusting nut allows the cross-section of a circumferential channel between the adjusting nut end face and the end face of the rotor or the shaft core to be adjusted, thereby adjusting the damping effect. What is disadvantageous about this solution is that it does not allow the prevention of unintentional adjustment or twisting of the adjusting nut, particularly in the area of greater frictional damping, i.e. when there is a minimal channel cross-section.

Additional similar rotation dampers having a circumferential adjustable channel are disclosed amongst others in WO 2018/165 840 A1, CN 2 05 330 352 U, CN 2 05 359 343 U and CN 2 05 729 235 U.

EP 0 742 381 B1 discloses a generic adjustable rotation damper that has a rotor which is mounted rotatably in a first part of a housing. The range of rotation is limited by at least one stop in the circumferential direction. In the circumferential direction, upstream and downstream of the at least one stop, a through-opening each is provided in an intermediate wall which separates the first part of the housing from the second part of the housing. A rotatably mounted control element is fitted in the second part of the housing, which control element has a groove that extends around the circumference in some areas and which is of variable depth and/or width over its extent. The through-openings are located in the radial direction in the area of the circumferential groove and are therefore fluidically connected to one another. Rotating the control element will allow adjustment of the depth and/or the width of the groove in the area of the two through-openings and thus of the flow resistance when the rotor moves. The adjustment range depends on how the groove is formed in the production process. The at least one rotor blade has a valve element that is arranged at the radially outer end of the rotor blade. The formation of this valve element additionally enables the rotation damper to provide damping depending on the direction of rotation. While it is possible for the fluid to flow through the valve element in the one direction of rotation, i.e. from one side of the rotor blade to the other side of the rotor blade, such flow will be blocked in the other direction of rotation.

The disadvantage of this design of a rotation damper is that producing the groove requires a time-consuming and complex manufacturing process.

It is the object of the invention, therefore, to further improve on a rotation damper of the type specified in the preamble of claim 1 in such a way that reliable adjustment of its damping is achieved in the mounted condition whilst avoiding the above mentioned shortcomings.

This object is accomplished in a first aspect of the invention by the characterizing features of claim 1 in conjunction with the features of its preamble.

The dependent claims relate to advantageous further embodiments of the invention.

In a known manner, a rotation damper comprises a substantially tubular housing with at least one stop. The stop extends radially inwards from an inner cylindrical surface of the housing. The tubular housing has a rotor chamber, which is delimited by the inner cylinder surface, and an adjustment chamber, which chambers are separated by a radially inwardly extending intermediate wall that is part of the housing. The intermediate wall has at least one through-opening which is part of a channel for viscous fluid. A rotor with at least one rotor blade, which is formed as a cylindrical segment, is introduced into the rotor chamber filled with the viscous fluid. The rotor is mounted therein for rotation about an axis of rotation. The rotor can be rotated from a first stop surface of the stop to a second stop surface of the stop. The rotor divides the rotor chamber into a first sub-chamber and a second sub-chamber which are fluidically connected to one another at least by the channel. A control element is introduced into the adjustment chamber, which control element is used to adjust the cross-sectional area of the channel.

According to the invention, the control element comprises a slide and a force transmission element. The slide has at least one protrusion that extends in the circumferential direction at least in some regions and complements the at least one intermediate wall through-opening, which is designed as a slot that extends at least partly in the circumferential direction, and the protrusion engages into the through-opening at least in some regions. The slide is designed to be axially movable along the axis of rotation such that the cross-sectional area of the channel can be adjusted by an axial movement of the slide. The cross-sectional area of the channel can be adjusted by moving the slide axially. This enables both cost-effective production and continuous adjustment of the damping behavior. Furthermore, the at least one through-opening is thus designed as a guide for the protrusion or the slide. This saves space for the required guide geometry in the adjustment chamber and ensures a more compact design.

Due to the interaction of the at least one through-opening with the at least one complementary protrusion, damping can be divided into two areas: the area where there is viscous, weaker damping and the area having stronger frictional damping. Viscous damping is obtained by the gap between the at least one protrusion and the end face of the rotor. Frictional damping results when the at least one protrusion comes into contact with the end face of the rotor, i.e. when the cross-section of the channel is minimal, in which case the design of the at least one through-opening as a guide for the corresponding complementary protrusion of the slide prevents rotation of the slide, and thus of the force transmission element/rotation element, thereby ensuring a constant channel cross-section. This helps to ensure constant damping characteristics.

In order to protect the interior of the housing from external influences, a cover element each, particularly a detachable one, is attached to the end faces of the housing to seal the latter.

Preferably, the two cover elements are each integrally bonded to the housing, in particular ultrasonically welded to it. This ensures quick and robust closure of the housing and prevents unintentional opening of the cover element.

The force transmission element is preferably designed to be rotatable and is held in position in the axial direction between the intermediate wall and the cover part. The force transmission element has an internal thread into which an external thread of a part of the slide engages. The protrusion of the slide is held in position in the through-opening in the circumferential direction. This means that a simple rotational movement of the force transmission element can cause an axial displacement of the slide.

According to another advantageous embodiment of the invention, the force transmission element has a drive structure, in particular a hexagonal socket, for a positive-locking tool at its end facing away from the slide. The drive structure for a positive locking tool allows a user to adjust the axial position of the slide in relation to the rotor in an easy way and without any assembly effort.

Preferably, a chamber is provided between the force transmission element and the slide, which chamber is fluidically connected to the rotor chamber via bores made in the slide. This allows the viscous fluid to flow into the chamber, thus reducing the effort required to seal the interior.

The viscous fluid is preferably in the form of silicone oil.

According to another advantageous embodiment of the invention, the at least one rotor blade has a groove on its end face facing the intermediate wall, which groove is associated with the through-opening and forms part of the channel. This allows the adjustment range of the opening cross-section of the channel to be increased without requiring any additional installation space.

At its end facing away from the intermediate wall, the rotor preferably has a coupling structure for connection to a drive, in particular for a hinge. This type of rotation damper can be used for various applications, especially also in the field of aircraft interiors.

On its side facing the intermediate wall, the rotor preferably has a centrally arranged bearing journal which engages in a centrally arranged mount in the intermediate wall and is supported there. Mounting the rotor in this way results in limited or minimized radial play of the rotor in the area facing the intermediate wall. Moreover, this results in a more stable bearing.

According to yet another advantageous embodiment of the invention, the rotor has two rotor blades and the housing has two stop protrusions. A first rotor blade is adapted to be rotated from a first stop surface of the first stop protrusion to a second stop surface of the second stop protrusion, and a second rotor blade is adapted to be rotated from the first stop surface of the second stop protrusion to the second stop surface of the first stop protrusion. Designing the rotor to have two rotor blades increases the displacement surface of the rotor and thus also generally increases the damping effect.

Preferably, the at least one rotor blade has a control element with legs arranged at an angle to each other. The control element on the rotor blade is mounted for movement in the circumferential direction. The control element engages radially around the outside of the rotor blade in such a way that a first and a second leg each are arranged on one side of the rotor blade and the third leg connecting the first and second legs is arranged on the radially outer surface. The maximum distance in the circumferential direction of the first and the second leg, and thus the length of the third leg, is greater than the maximum distance between the first lateral surface and the second lateral surface of the at least one rotor blade in the circumferential direction. As a result of this control element design, when the rotor blade rotates about the axis of rotation in one direction, the leg arranged in the direction of rotation is in contact with the rotor blade. The leg of the control element facing away from the direction of rotation is arranged at a distance from the rotor blade.

Preferably, a recess adapted to the third leg is provided in the radially outer surface of the rotor blade, into which the third leg of the control element is introduced. This allows the radially outer surface of the third leg to be aligned with the radially outer surface of the rotor blade that lies outside the recess, such that the assembly essentially seals against the inside of the housing and cannot be moved in an axial direction.

According to another advantageous embodiment of the invention, the first and/or the second leg extend at least partially over the cross-sectional area of the groove of the rotor.

Preferably, the first leg is longer than the second leg. The first leg extends completely radially into the groove, and the second leg extends only partially radially into the groove. This results in damping that is adjustable depending on the direction of rotation. Because the first leg extends completely radially into the groove, the second leg extends only partially radially into the groove, and the leg facing away from the direction of rotation is provided at a distance from the rotor blade, greater damping is achieved during rotation in the direction of the first leg.

The control element is preferably designed as a molding that was produced in a primary shaping process, preferably as a bent part, in particular made of stainless steel. This makes the control element corrosion-resistant and durable.

The viscous fluid is preferably located in the rotor chamber and in the adjustment chamber, so that the rotor chamber and the adjustment chamber serve as an oil chamber. This diminishes wear on the moving parts in the adjustment chamber and reduces oil loss from the rotor chamber.

Additional advantages, features and possible applications of the present invention may be noted from the following description in which reference is made to the embodiments illustrated in the drawings.

Throughout the description, the claims and the drawings, those terms and associated reference signs are used as stated in the list of reference signs below. In the drawings,

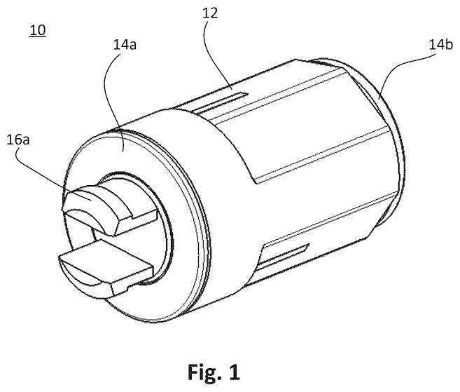

FIG. 1 is a perspective view of the rotation damper as a whole, taken at an angle from above;

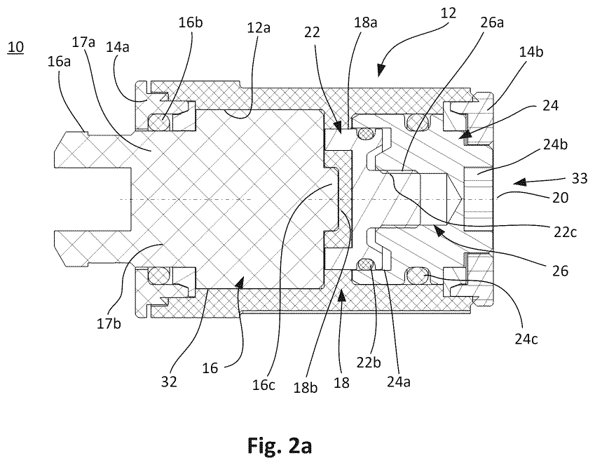

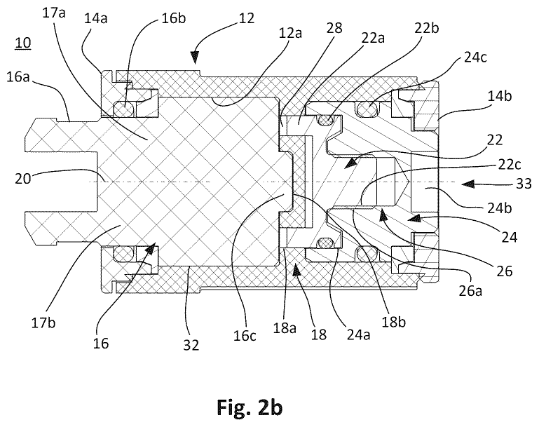

FIG. 2a is a longitudinal sectional view of the rotation damper, with the slide being in a first end position thereof;

FIG. 2b is a longitudinal sectional view of the rotation damper, with the slide being in a second end position thereof;

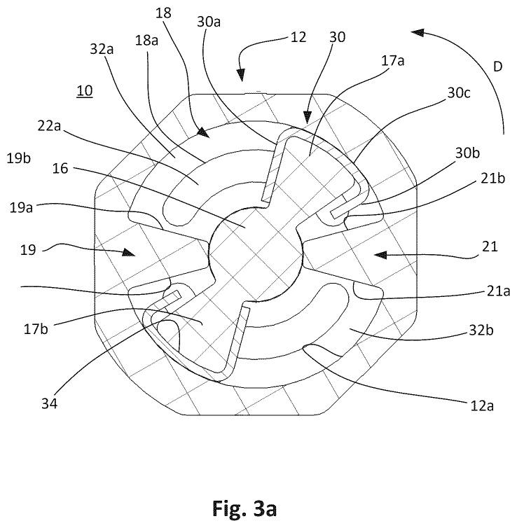

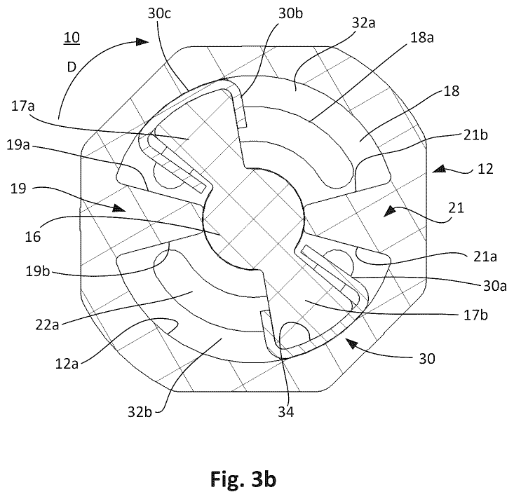

FIG. 3a is a cross-sectional view of the rotation damper, with the rotor comprising a control element and being in a first position thereof;

FIG. 3b is a cross-sectional view of the rotation damper according to FIG. 3a, with the rotor being in a second position thereof;

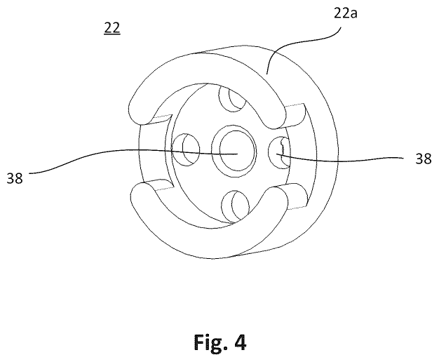

FIG. 4 is a perspective view of a second embodiment of the slide, taken at an angle;

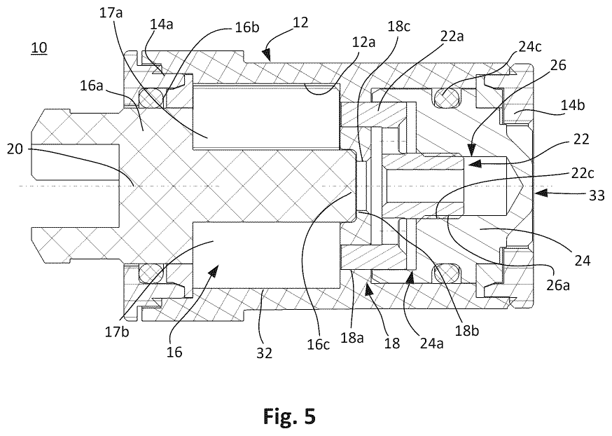

FIG. 5 is a longitudinal sectional view of a second embodiment of the rotation damper, with the slide being in a first end position thereof; and

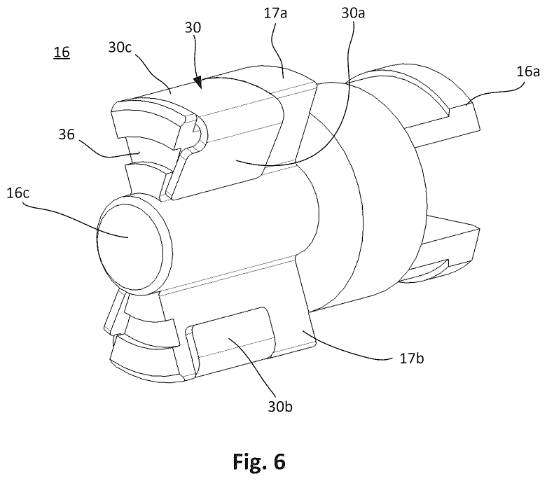

FIG. 6 is a perspective view, taken at an angle from above, of the rotor of FIG. 3a.

FIGS. 1 to 3b and 5 each show a rotation damper 10 having a tubular housing 12. On either of its two end faces, the housing 12 is provided with a cover element 14a, 14b which cover elements 14a, 14b are each ultrasonically welded to the housing 12.

FIG. 1 is a perspective view of the rotation damper 10 as a whole. On the side of the first cover element 14a, a coupling structure 16a of a rotor 16 is provided and guided by the first cover element 14a and protrudes from the housing 12. A seal 16b—see FIG. 2a—is arranged between the rotor 16 and the cover element 14a in the radial direction. The housing 12 is substantially cylindrical in shape.

FIG. 2a is a longitudinal sectional view of the rotation damper 10. Within the housing 12, the rotor 16, which is designed as a partial cylinder with two rotor blades 17a, 17b, is introduced into a rotor chamber 32. The radially outer lateral surface of the rotor blades 17a, 17b of the rotor 16 rests against the inner lateral surface 12a of the housing 12. Two radially inwardly oriented stop protrusions 19, 21 are formed on the inner lateral surface 12a of the housing 12 in some areas. Between a stop surface 19a, 19b of the first stop protrusion 19—see FIG. 3a—up to a stop surface 21a, 21b of a second stop protrusion 21—see FIG. 3a, the rotor blades 17a, 17b are each mounted for rotation about an axis 20 in certain areas. The coupling structure 16a is formed at one axial end. At the other axial end, the rotor 16 rests against an intermediate wall 18, which is formed in a cross-sectional plane of the housing 12.

The intermediate wall 18 is formed in one piece with the housing 12 and has through-openings 18a. Furthermore, the intermediate wall 18 is provided with a centering recess 18b. A centering pin 16c of the rotor 16 engages in this centering recess 18b and is mounted in it.

The adjustment chamber 33, in which a slide 22 is arranged, is formed on the side of the intermediate wall 18 facing away from the rotor 16. The slide 22 has two through-protrusions 22a. One through-protrusion 22a each is mounted so as to be displaceable in a through-opening 18a and is guided axially. The free end of the through-protrusions 22a delimits a channel 28 in an axial direction.

The end of the slide 22 facing away from the intermediate wall 18 is displaceably mounted in a receptacle 24a of a rotation element 24 and rests laterally against the latter. A circumferential seal 22b is arranged between the receptacle 24a and the slide 22. The rotating element 24 rests against an axial stop on the intermediate wall 18. At its other axial end, the rotation element 24 abuts the cover element 14b in some areas. This fixes the rotation element 24 in both axial directions. The rotation element 24 is designed to rotate about the axis of rotation 20. The rotation element 24 has a drive structure 24b for a tool on its end facing away from the slide 22, which is flush with the second cover element 14b in the axial direction.

The receptacle 24a has a central bore 26 in it, in which a pin-shaped end of the slide 22, which faces the rotation element 24, is arranged. The inner wall of the bore 26 is formed in some areas as an internal thread 26a, which engages in an external thread 22c of the pin-shaped end of the slide 22. By rotating the rotation element 24, the slide 22 can be moved to a limited extent in an axial direction along the axis of rotation 20 between two end positions. The first end position is shown in FIG. 2a.

The first end position is characterized by the fact that the end face of the slide 22 rests against the end face of the rotor 16, thereby achieving frictional damping.

FIG. 2b is a longitudinal sectional view of the rotation damper 10 of FIG. 2a, with the slide 22 being in its second end position. The second end position is characterized by the fact that the end of the slide 22 facing the rotation element 24 is essentially in contact with the receptacle 24a of the rotation element 24. This means that the channel 28 is formed between the end of the through-protrusion 22a facing the rotor 16 and the end of the rotor 16 facing the intermediate wall 18. This results in viscous damping.

Due to the formation of the channel 28 in the second end position, a fluid introduced into the rotor chamber 32 can flow from one side of a rotor blade 17a, 17b to the other side of the rotor blade 17a, 17b. Moving the slide 22 in the axial direction changes the cross-section of the channel 28.

The slide 22 can be displaced between a maximum damping position, in which the channel 28 has its smallest cross-section-first end position- and a minimum damping position, in which the channel 28 has its largest cross-section-second end position.

FIG. 3a is a cross-sectional view of the rotation damper 10, in which the rotor blades 17a, 17b of the rotor 16 according to a second embodiment have a control element 30 and are in a first position. In FIG. 3a, the rotor is turned in the direction of rotation D.

In this view, the first rotor blade 17a is arranged in a first rotor chamber 32a, and the second rotor blade 17b is arranged in a second rotor chamber 32b of the rotor chamber 32. The intermediate wall 18 has a through-opening 18a in each of the two rotor chambers 32a, 32b. The rotor blades 17a, 17b each have a recess 34 at their radial end, which extends in the axial direction in some areas in the rotor blades 17a, 17b.

A control element 30 each is introduced into the recess 34. The control element 30 has three legs 30a, 30b, 30c. A first leg 30a is located on one side of the rotor blade 17a, 17b, a second leg 30b is located on the other side of the rotor blade 17a, 17b and a third leg 30c is arranged in the recess 34.

At the end of the rotor blades 17a, 17b associated with the intermediate wall 18, a groove 36 is each formed opposite the through-opening 18a. This groove is shown in FIG. 6.

The first leg 30a rests against the side of the rotor blade 17a, 17b formed in the direction of rotation D. The first leg 30a extends in a radial direction over the length of the rotor blade 17a, 17b. The second leg 30b is arranged at a distance from the rotor blade 17a, 17b on the side of the rotor blade 17a, 17b opposite the direction of rotation D. The second leg 30b extends in the radial direction in some areas along the rotor blade 17a, 17b. The third leg 30c connects the first leg 30a and the second leg 30b in the circumferential direction.

In the axial direction, the first leg 30a extends over the entire cross-sectional area of the groove 36.

The second leg 30b does not extend at all or only partially over the cross-sectional area of the groove 36.

FIG. 3b is a longitudinal sectional view of the rotation damper 10 of FIG. 3a, with the rotor 16 being in its second end position. In this case, the direction of rotation D is opposite to the direction of rotation D of FIG. 3a. As a result, the second legs 30b each rest against the rotor blades 17a, 17b, and the first leg 30a is arranged at a distance from the rotor blade 17a, 17b. As a result, during rotation in the direction of rotation D, the fluid can flow through the channel 28 and the groove 36 into the gap between the first leg 30a and the rotor blade 17a, 17b, and thus from the side that is oriented in the direction of rotation D, to the other side of the rotor blade 17a, 17b.

This design of the control element 30 allows the damping to be adjusted depending on the direction of rotation. Rotation of the rotor 16 in the direction of rotation D of FIG. 3a thus results in stronger damping than rotation of the rotor 16 in the direction of rotation D of FIG. 3b.

FIG. 4 is a view of an embodiment of the slide 22.

The slide 22 has two through-protrusions 22a and multiple bores 38.

FIG. 5 is a longitudinal sectional view of a second embodiment of the rotation damper 10, with the slide 22 being in a first end position thereof.

This embodiment is configured in accordance with the embodiment of FIG. 2a, with the rotor blades arranged rotated by 90° around the axis of rotation 20. In addition, the slide 22 of this embodiment is designed in accordance with the embodiment of FIG. 4. Furthermore, this embodiment has an opening 18c of the intermediate wall 18 in the centering recess 18 b.

When filling the damper 10, the fluid can flow from the rotor chambers 32a, 32b into the bore 26 through the holes 38 and the opening 18c in the intermediate wall 18. As a result, the rotor chamber 32 and the adjustment chamber 33 are fluidically connected.

When the slide 22 is axially displaced, the rotation chamber and the adjustment chamber act as a pressure chamber.

FIG. 6 is a perspective view, taken at an angle from above, of the rotor 16 of FIG. 3a.

The rotor blades 17a, 17b each have a groove 36 which fluidically connects one side of the rotor blade 17a, 17b to the other side of the rotor blade 17a, 17b.

As the slide 22 is designed to be axially displaceable in the through-opening 18a, damping can be easily adjusted via the drive structure 24b depending on the respective application. Moreover, providing the control element 30 and introducing the control element 30 into the groove 36 also allows damping to be provided that is dependent on the direction of rotation.

### LIST OF REFERENCE SIGNS

10 rotation damper
12 housing
12a inner lateral surface of housing 12
14a first cover element
14b second cover element
16 rotor
16a coupling structure of rotor 16
16b seal of rotor 16
16c centering pin of rotor 16
17a first rotor blade
17b second rotor blade
18 intermediate wall
18a through-opening in intermediate wall 18
18b centering recess in intermediate wall 18
18c opening in intermediate wall 18
19 first stop protrusion
19a first stop surface of stop protrusion 19
19b second stop surface of stop protrusion 19
20 axis of rotation
21 second stop protrusion
21a first stop surface of stop protrusion 21
21b second stop surface of stop protrusion 21
22 slide
22a through-protrusion of slide 22
22b seal of slide 22
22c external thread of slide 22
24 rotation element
24a receptacle of rotation element 24
24b drive structure of rotation element 24
24c seal of rotation element 24
26 bore of rotation element 24
26a internal thread of bore 26
28 channel
30 control element
30a first leg of control element 30
30b second leg of control element 30
30c third leg of control element 30
32 rotor chamber
32a first rotor chamber
32b second rotor chamber
33 adjustment chamber
34 recess
36 groove
38 bore

1-17. (canceled)

18. A rotation damper (10), comprising
a substantially tubular housing (12) with at least one stop (19a, 19b) extending radially inwards from an inner cylindrical surface (12a) of the housing (12),
a rotor chamber (32) being delimited by the inner cylindrical surface (12a), and
an adjustment chamber,
wherein the rotor chamber (32) and the adjustment chamber are separated by an intermediate wall (18) in a form of a part of the housing (12), the intermediate wall extends radially inwards, wherein the intermediate wall (18) comprises at least one through-opening (18a) that is part of a channel (28) for viscous fluid, with a rotor (16) with at least one rotor blade (17a, 17b), which is formed as a cylindrical segment, being introduced into the rotor chamber (32) filled with the viscous fluid, being rotatably mounted therein about an axis of rotation (20), and being adapted to be rotated from a first stop surface (19a, 21a) of the stop (19, 21) to a second stop surface (19b, 21b) of the stop (19, 21),
wherein the rotor (16) divides the rotor chamber (32) into a first sub-chamber and a second sub-chamber that are fluidically connected together at least by means of the channel (28),
wherein a control element is introduced into the adjustment chamber, the control element being used to adjust the cross-sectional area of the channel (28), and
wherein the control element comprises a slide (22) and a force transmission element (24), which slide (22) has at least one protrusion (22a) which extends in the circumferential direction in some regions and complements the at least one intermediate wall (18) through-opening (18a), which is a slot that extends at least partly in the circumferential direction, and which protrusion (22a) engages into the through-opening (18a) at least in some regions, with the slide (22) being axially movable along the axis of rotation (20) such that the cross-sectional area of the channel

(28) is adjustable by an axial movement of the slide (22).

19. The rotation damper according to claim 18, wherein each end face of the housing (12) comprises a cover element (14a, 14b) that is a detachable cover element attached thereto and seals the housing (12).

20. The rotation damper according to claim 19, wherein the two cover elements (14a, 14b) are each materially bonded to the housing (12) by ultrasonic welding.

21. The rotation damper according to claim 19, wherein the force transmission element (24) is rotatable and is axially fixed in the axial direction between the intermediate wall (18) and the cover part (14b), the force transmission element (24) comprises an internal thread (26a) where an external thread (22c) of a part of the slide (22) engages, with the protrusion (22a) of the slide (22) in the through-opening (18a) being fixed in the circumferential direction by the opening.

22. The rotation damper according to claim 18, wherein the force transmission element at its end facing away from the slide (22), comprises a drive structure (24b) that is a hexagonal socket for a positive-locking tool.

23. The rotation damper according to claim 18, wherein a chamber is provided between the force transmission element (24) and the slide (22), the chamber is fluidically connected to the rotor chamber (32) via bores (38) in the slide (22) and an opening (18c) in the intermediate wall (18).

24. The rotation damper according to claim 18, wherein the viscous fluid is in a form of an oil.

25. The rotation damper according to claim 18, wherein the at least one rotor blade (17a, 17b) comprises a groove (36) on its side facing the intermediate wall (18), and the groove (36) is associated with the through-opening (18a) and is part of the channel (28).

26. The rotation damper according to claim 18, wherein the rotor (16), at its end facing away from the intermediate wall (18), comprises a coupling structure (16a) for connection to a drive, in particular for a hinge.

27. The rotation damper according to claim 18, wherein the rotor (16), at its end facing the intermediate wall (18), comprises a centrally arranged bearing pin (16c), the bearing pin (16c) engages in a centrally arranged receptacle (18b) of the intermediate wall (18) and is mounted there.

28. The rotation damper according to claim 18, wherein the rotor (16) comprises a first and a second rotor blades (17a, 17b) and the housing (12) comprises two stop protrusions (19, 21), wherein the first rotor blade (17a) is adapted to be rotated from a first stop surface (19a) of the first stop protrusion (19) to a second stop surface (21b) of the second stop protrusion (21), and the second rotor blade (17b) is adapted to be rotated from the first stop surface (21a) of the second stop protrusion (21) to the second stop surface (19b) of the first stop protrusion (19).

29. The rotation damper according to claim 18, wherein the at least one rotor blade (17a, 17b) each comprises a control element (30) with legs (30a, 30b, 30c) each arranged at an angle to one another,
the control element (30) is mounted on the rotor blade (17a, 17b) so as to be movable in the circumferential direction, for which purpose the control element (30) embraces the rotor blade (17a, 17b) radially on the outside in such a way that a first and second leg (30a, 30b) are each arranged on one side of the rotor blade (17a, 17b) and the third leg (30c) that connects the first and second legs (30a, 30b) is arranged on the radially outer surface with the maximum distance in the circumferential direction of the first and second legs (30a, 30b), and
the length of the third leg (30c) is greater than the maximum distance between the first lateral surface and the second lateral surface of the at least one rotor blade (17a, 17b) in the circumferential direction.

30. The rotation damper according to claim 29, wherein a recess (34) adapted to the third leg (30c) is provided in the radially outer surface of the rotor blade (17a, 17b), and the third leg (30c) of the control element (30) is introduced into the recess (34).

31. The rotation damper according to claim 29, wherein the first and/or second leg (30a, 30b) extends at least in part over the cross-sectional area of the groove (36) of the rotor (16).

32. The rotation damper according to claim 29, wherein the first leg (30a) is longer than the second leg (30b), the first leg (30a) extends completely radially into the groove (36), and the second leg (30b) extends only partially radially into the groove (36).

33. The rotation damper according to claim 29, wherein the control element (30) is designed as a molding that is produced in a primary shaping process.

34. The rotation damper according to claim 33, wherein the control element (30) is produced as a bent part made of stainless steel.

35. The rotation damper according to claim 18, wherein the viscous fluid is contained in the rotor chamber (32) and in the adjustment chamber (33), and the rotor chamber (32) and the adjustment chamber (33) serve as an oil chamber.
